(19) United States
(12) Patent Application Publication
(10) Pub. No.: US 2020/0400038 A1
(43) Pub. Date: Dec. 24, 2020

(54) ROTARY MACHINE

(71) Applicant: Mitsubishi Hitachi Power Systems, Ltd., Kanagawa (JP)

(72) Inventors: Toshihiko AZUMA, Tokyo (JP); Ryuichi UMEHARA, Tokyo (JP)

(21) Appl. No.: 16/767,348

(22) PCT Filed: Dec. 14, 2018
(86) PCT No.: PCT/JP2018/046117

§ 371 Date: May 27, 2020

(30) Foreign Application Priority Data
Dec. 15, 2017 (JP) 2017-240975

(51) Int. Cl. F01D 25/06; F01D 5/14; F01D 5/28

(52) U.S. Cl. CPC F01D 25/06; F01D 5/147; F05D 2260/96; F05D 2220/32; F01D 5/28

(57) ABSTRACT

A rotary machine includes a rotary shaft configured to rotate around an axis and a blade row including a plurality of blades at intervals in a circumferential direction of the axis. Each of the blades includes a fiber laminate obtained by laminating a plurality of fiber sheets and a resin used for forming an outer shape of the blade by impregnating the fiber laminate. At least two of the blades in the blade row have fiber laminates having different structures.

### TECHNICAL FIELD

The present invention relates to a rotary machine.

Priority is claimed on Japanese Patent Application No. 2017-240975, filed Dec. 15, 2017, the content of which is incorporated herein by reference.

### BACKGROUND ART

In rotary machines such as gas turbines or jet engines in which energy of fluids is converted into rotary motion through a plurality of blades, a vibration phenomenon called a flutter may occur during starting-up or during a high-load operation in some cases. On the other hand, there is also known a technology in which blades are formed of a carbon fiber reinforced plastic (CFRP) to reduce a weight (for example, refer to Patent Literature 1). Due to such a reduction in weight and an increase in length of a blade, the resistance to a flutter has become important.

### CITATION LIST

### Patent Literature

[Patent Literature 1]

Japanese Unexamined Patent Application, First Publication No. 2013-231402

### SUMMARY OF INVENTION

### Technical Problem

Incidentally, in order to increase the resistance to a flutter, it is necessary to increase the rigidity of a blade itself. As a method for increasing the rigidity of a blade, a method for increasing a thickness of the blade or increasing a cord length of the blade is conceivable. However, when such a method is used, aerodynamic performance is affected. Thus, there is a demand for a method for improving the resistance to a flutter without changing the shape of a blade.

An object of the present invention is to provide a rotary machine capable of reducing vibration stress of a blade row.

### Solution to Problem

According to a first aspect of the present invention, a rotary machine includes: a rotary shaft configured to rotate around an axis; and a blade row including a plurality of blades at intervals in a circumferential direction of the axis, wherein each of the blades includes: a fiber laminate obtained by laminating a plurality of fiber sheets; and a resin used for forming an outer shape of the blade by impregnating the fiber laminate, and at least two of the blades in the blade row have fiber laminates having different structures.

During an operation of the rotary machine, the blade is excited due to a fluid flowing around the blade and vibration stress is generated.

Fiber structured bodies of at least two of the blades in the blade row have different structures. Thus, a vibration form of the blade row no longer matches the excitation mode due to the fluid. According to such a constitution, since the vibration form of the blade row does not coincide with the excitation mode in which the blade is caused to be excited, it is possible to reduce vibration stress of the blade row.

In the rotary machine, the plurality of blades may have the same outer shape.

According to such a constitution, since the natural blade frequencies of the plurality of blades can be differentiated while the blades have the same shape, it is possible to reduce vibration stress of the blade row without affecting aerodynamic performance.

In the rotary machine, in the fiber laminates having structures different from each other, fiber directions of some of fiber sheets of one layer or more among the plurality of fiber sheets may be different.

According to such a constitution, it is possible to easily make the blades have the same shape.

In the rotary machine, in the fiber laminates having structures different from each other, fiber types of some of fiber sheets of one layer or more among the plurality of fiber sheets may be different.

According to such a constitution, it is possible to differentiate structures of the blades without changing a fiber direction.

In the rotary machine, in the fiber laminates having structures different from each other, fiber diameters of some of fiber sheets of one layer or more among the plurality of fiber sheets may be different.

According to such a constitution, it is possible to differentiate structures of the blades without changing a fiber direction.

### Advantageous Effects of Invention

According to an aspect of the present invention, it is possible to reduce vibration stress of a blade row.

### BRIEF DESCRIPTION OF DRAWINGS

FIG. 1 is a constitution diagram illustrating a schematic constitution of a jet engine in a first embodiment of the present invention.

FIG. 2 is a front view of a compressor in the first embodiment of the present invention.

FIG. 3 is a cross-sectional view of a rotor blade in the first embodiment of the present invention.

FIG. 4A is a plan view of a 0° direction fiber sheet.

FIG. 4B is a plan view of a 90° direction fiber sheet.

FIG. 4C is a plan view of a 45° direction fiber sheet.

FIG. 4D is a plan view of a −45° direction fiber sheet.

FIG. 5 is a schematic diagram for explaining a fiber direction of a fiber sheet constituting a fiber laminate of a first rotor blade.

FIG. 6 is a schematic diagram for explaining a fiber direction of a fiber sheet constituting a fiber laminate of a second rotor blade.

FIG. 7 is a graph for explaining a ratio of fiber sheets constituting four types of fiber laminates.

FIG. 8 is a graph for describing a frequency shift in a T1 mode (a twist mode) of four types of fiber laminates.

FIG. 9 is a graph for describing a frequency shift in a B1 mode (a bending mode in a blade height direction) of four types of fiber laminates.

FIG. 10A is a graph having a horizontal axis representing a blade frequency, having a vertical axis representing damping (aerodynamic damping), and obtained by plotting diameter modes of nodes of the blade corresponding to the number of blades of the blade and is a graph of a tune system in which there is no variation in the blade frequency.

FIG. 10B is a graph having a horizontal axis representing a blade frequency, having a vertical axis representing damping (aerodynamic damping), and obtained by plotting diameter modes of nodes of the blade corresponding to the number of blades of the blade and is a graph of a mistune system in which a variation of the blade frequency is intermediate.

FIG. 10C is a graph having a horizontal axis representing a blade frequency blade, having a vertical axis representing damping (aerodynamic damping), and obtained by plotting diameter modes of nodes of the blade corresponding to the number of blades of the blade and is a graph of a random mistune system in which a variation of the blade frequency is large.

FIG. 11 is a schematic diagram for explaining a fiber direction of a fiber sheet constituting a fiber laminate of a second rotor blade in a modified example of the first embodiment of the present invention.

FIG. 12 is a schematic diagram for explaining a fiber direction of a fiber sheet constituting a fiber laminate of a second rotor blade in a second embodiment of the present invention.

FIG. 13 is a front view of a compressor in a fourth embodiment of the present invention.

### DESCRIPTION OF EMBODIMENTS

### First Embodiment

A rotary machine in a first embodiment of the present invention will be described in detail below with reference to the drawings.

Although a case in which the present invention is applied to a jet engine (an aircraft gas turbine) will be described in the following description, the present invention can also be applied to other rotary machines including a rotary shaft configured to rotate around an axis and a blade row including a plurality of blades provided at intervals in a circumferential direction of the axis, for example, a power generation gas turbine.

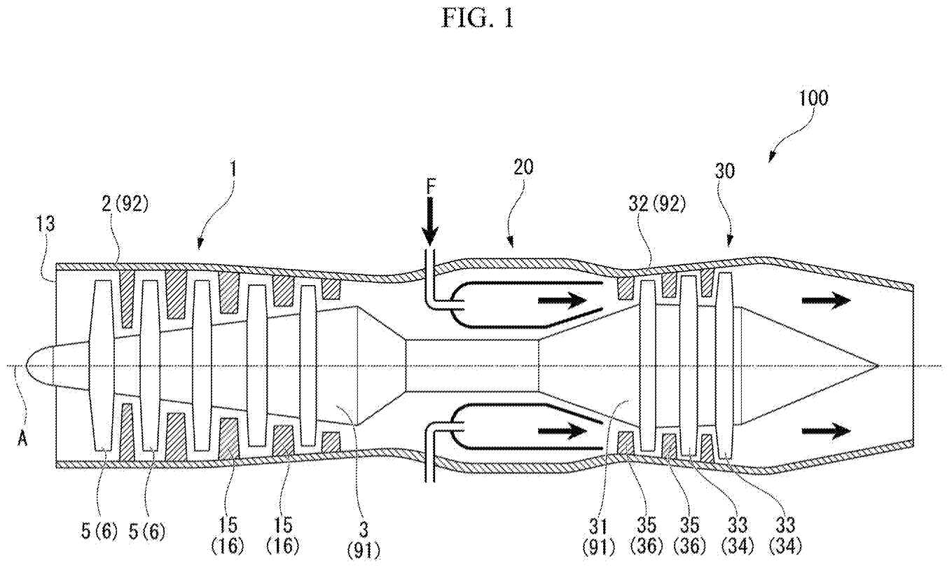

As illustrated in FIG. 1, a jet engine 100 in this embodiment is for obtaining the thrust of an aircraft. The jet engine 100 mainly includes a compressor 1, a combustion chamber 20, and a turbine 30.

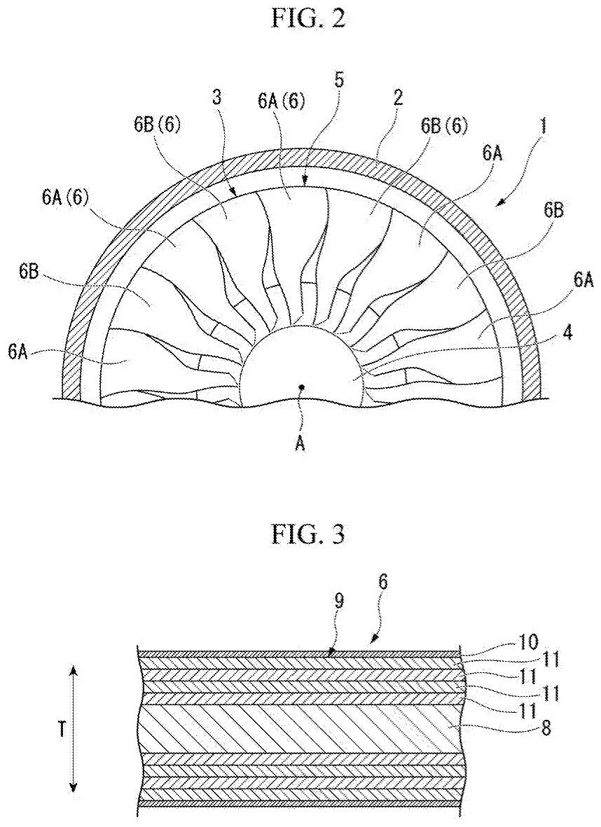

The compressor 1 generates high-pressure air by compressing air taken in from an intake duct 13. As illustrated in FIGS. 1 and 2, the compressor 1 includes a compressor rotor 3 and a compressor casing 2. The compressor casing 2 covers the compressor rotor 3 from an outer circumferential side and extends along an axis A.

A plurality of compressor rotor blade rows 5 arranged at intervals in a direction of the axis A are provided on an outer circumferential surface of the compressor rotor 3. Each of the compressor rotor blade rows 5 includes a plurality of compressor rotor blades 6.

The compressor rotor blades 6 of each of the compressor rotor blade rows 5 are arranged above the outer circumferential surface of the compressor rotor 3 at intervals in a circumferential direction of the axis A.

A plurality of compressor stator blade rows 15 arranged at intervals in the direction of the axis A are provided on an inner circumferential surface of the compressor casing 2. These compressor stator blade rows 15 are arranged alternately with respect to the compressor rotor blade rows 5 in the direction of the axis A. Each of the compressor stator blade rows 15 includes a plurality of compressor stator blades 16.

The compressor stator blades 16 of each of the compressor stator blade rows 15 are arranged above the inner circumferential surface of the compressor casing 2 at intervals in the circumferential direction of the axis A.

In the combustion chamber 20, a combustion gas G is generated by mixing a fuel F with the high-pressure air generated using the compressor 1 and burning the mixture. The combustion chamber 20 is provided between a casing 2 and the turbine casing 32 of the turbine 30. The combustion gas G generated using the combustion chamber 20 is supplied to the turbine 30.

The turbine 30 is driven using a high-temperature and high-pressure combustion gas G generated using the combustion chamber 20. To be more specific, the turbine 30 causes the high-temperature and high-pressure combustion gas G to expand and converts heat energy of the combustion gas G into rotational energy. The turbine 30 includes a turbine rotor 31 and the turbine casing 32.

The turbine rotor 31 extends along the axis A. A plurality of turbine rotor blade rows 33 arranged at intervals in the direction of the axis A are provided on an outer circumferential surface of the turbine rotor 31. Each of the turbine rotor blade rows 33 includes a plurality of turbine rotor blades 34. The turbine rotor blades 34 of each of the turbine rotor blade rows 33 are arranged above the outer circumferential surface of the turbine rotor 31 at intervals in the circumferential direction of the axis A.

The turbine casing 22 covers the turbine rotor 31 from the outer circumferential side. A plurality of turbine stator blade rows 35 arranged at intervals in the direction of the axis A are provided on the inner circumferential surface of the turbine casing 22. The turbine stator blade rows 35 are arranged alternately with respect to the turbine rotor blade rows 33 in the direction of the axis A. Each of the turbine stator blade rows 35 includes a plurality of turbine stator blades 36. The turbine stator blades 36 of each of the turbine stator blade rows 35 are arranged above the inner circumferential surface of the turbine casing 22 at intervals in the circumferential direction of the axis A.

The compressor rotor 3 and the turbine rotor 31 are integrally connected in the direction of the axis A. A gas turbine rotor 91 is constituted of the compressor rotor 3 and the turbine rotor 31. Similarly, the compressor casing 12 and the turbine casing 22 are integrally connected along the axis A. A gas turbine casing 92 is constituted of the compressor casing 12 and the turbine casing 22.

The gas turbine rotor 91 is integrally rotatable around the axis A inside the gas turbine casing 92.

Each of the compressor rotor blades 6 (hereinafter referred to as a “rotor blade 6”) is mainly formed of a carbon fiber reinforced plastic (CFRP). The CFRP has a fiber laminate obtained by laminating a fiber sheet made of a plurality of carbon fibers and a resin used for impregnating the fiber laminate. The resin forms an outer shape of the rotor blade.

The carbon fibers constituting the fiber sheet are aligned in a fiber direction. That is to say, the fiber sheet is formed so that directions in which the plurality of carbon fibers constituting the fiber sheet extend are the same.

Also, examples of the resin used for impregnating the fiber laminate include an ultraviolet curable resin, a thermosetting resin, and the like.

As illustrated in FIG. 3, the rotor blade 6 includes a core member 8, a fiber laminate 9 configured to cover the core member 8, and a resin 10 used for impregnating the fiber laminate 9 to form an outer shape of the rotor blade 6. The fiber laminate 9 is obtained by laminating a plurality of fiber sheets 11 and is arranged so that the fiber sheets 11 are in surface contact with a surface of the core member 8.

The core member 8 is arranged at a center of the rotor blade 6 in a blade thickness direction T.

A fiber direction of the fiber sheets 11 constituting the fiber laminate 9 will be defined below.

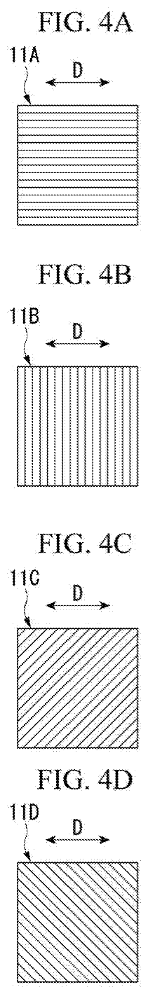

As illustrated in FIG. 4A, when the fiber sheets 11 are viewed in a plan view, the fiber sheets 11 in which the carbon fibers extend in a predetermined one direction D are defined as 0° direction fiber sheets 11A.

As illustrated in FIG. 4B, the fiber sheets 11 in which the carbon fibers extend in a direction intersecting that of the carbon fibers of the 0° direction fiber sheets 11A at an angle of 90° are defined as 90° direction fiber sheets 11B. That is to say, the carbon fibers of the 0° direction fiber sheets 11A are substantially orthogonal to the carbon fibers of the 90° direction fiber sheets 11B.

As illustrated in FIG. 4C, the fiber sheets 11 in which the carbon fibers extend in a direction intersecting that of the carbon fibers of the 0° direction fiber sheets 11A at an angle of 45° are defined as 45° direction fiber sheets 11C.

As illustrated in FIG. 4D, the fiber sheets 11 in which the carbon fibers extend in a direction intersecting that of the carbon fibers of the 0° direction fiber sheets 11A at an angle of −45° are defined as −45° direction fiber sheets 11D. That is to say, the carbon fibers of the 45° direction fiber sheets 11C are substantially orthogonal to the carbon fibers of the −45° direction fiber sheets 11D.

As illustrated in FIG. 2, each of the compressor rotor blade rows 5 in this embodiment (hereinafter referred to as a “rotor blade row 5”) includes a plurality of first rotor blades 6A (base rotor blades) forming a first structure and a plurality of second rotor blades 6B forming a second structure having a structure different from the first structure. The first rotor blades 6A and the second rotor blades 6B are arranged differently from each other in the circumferential direction. That is to say, the first rotor blades 6A and the second rotor blades 6B are arranged to be adjacent in the circumferential direction. The first rotor blades 6A and the second rotor blades 6B have the same outer shape. That is to say, the resin 10 forming the outer shape of the first rotor blades 6A and the resin 10 forming the outer shape of the second rotor blades 6B have the same shape.

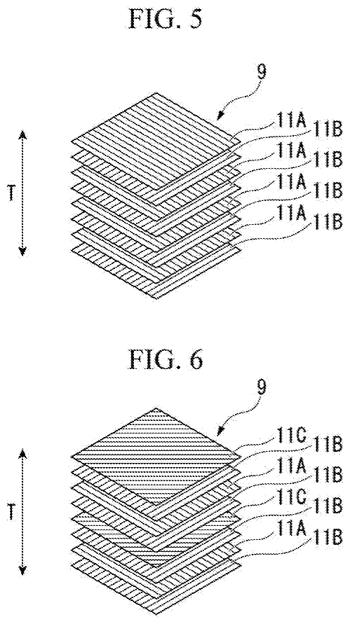

FIG. 5 is a schematic diagram for explaining the fiber direction of the fiber sheets 11 constituting the fiber laminate 9 of the first rotor blades 6A among the plurality of rotor blades 6 constituting the rotor blade rows 5. The fiber laminate 9 includes the plurality of 0° direction fiber sheets 11A and the plurality of 90° direction fiber sheets 11B. The 0° direction fiber sheets 11A and the 90° direction fiber sheets 11B are alternately laminated in the blade thickness direction T.

That is to say, in the fiber laminate 9 of the first rotor blades 6A, the carbon fibers of the fiber sheets 11 adjacent in the blade thickness direction T are orthogonal to each other.

FIG. 6 is a schematic diagram for explaining the fiber direction of the fiber sheets 11 constituting the fiber laminate 9 of the second rotor blades 6B among the plurality of rotor blades 6 constituting the rotor blade rows 5. The fiber laminate 9 includes the plurality of 0° direction fiber sheets 11A, the plurality of 90° direction fiber sheets 11B, and the plurality of 45° direction fiber sheets 11C. The 0° direction fiber sheets 11A and the 90° direction fiber sheets 11B are alternately laminated and any of the fiber sheets 11 is changed to the 45° direction fiber sheets 11C.

When the fiber laminate 9 of the second rotor blades 6B has the 45° direction fiber sheets 11C, the first rotor blades 6A and the second rotor blades 6B have fiber laminates 9 have structures in which the fiber laminates 9 are different from each other.

Since the first rotor blades 6A and the second rotor blades 6B have different structures, the natural blade frequency of the first rotor blades 6A is different from the natural blade frequency of the second rotor blades 6B. That is to say, since there is a variation between the natural blade frequencies of the rotor blades 6 constituting the rotor blade rows 5, the rotor blade rows 5 are in a so-called mistuned state.

During an operation of the jet engine, each of the rotor blades 6 is excited due to air flowing around the rotor blade 6 and vibration stress is generated. Since the rotor blades 6 are arranged at equal intervals in the circumferential direction, excitation modes are formed at equal intervals in the circumferential direction.

On the other hand, in the plurality of rotor blades 6 constituting the rotor blade rows 5 in this embodiment, the rotor blades 6 having different natural blade frequencies are arranged differently from each other. Thus, vibration forms of the rotor blade rows 5 are not formed at equal intervals in the circumferential direction.

According to the above embodiment, since the vibration forms of the rotor blade rows 5 do not coincide with the excitation modes in which the rotor blades 6 are caused to be excited, it is possible to reduce vibration stress of the rotor blade rows 5.

Also, since the natural blade frequencies of the plurality of rotor blades 6 can be differentiated while the rotor blades 6 have the same shape, it is possible to reduce vibration stress of the rotor blade rows 5 without affecting aerodynamic performance. Furthermore, by differentiating the fiber directions, it is possible to easily make the first rotor blades 6A and the second rotor blades 6B have the same shape by differentiating the structures of the first rotor blades 6A and the second rotor blades 6B.

Although the second rotor blades 6B in the above embodiment having a structure different from the structure of the first rotor blades 6A serving as base blades are constituted of three types of fiber sheets 11, i.e., the 0° direction fiber sheets 11A, the 90° direction fiber sheets 11B, and the 45° direction fiber sheets 11C, the present invention is not limited thereto.

For example, in addition to the 0° direction fiber sheets 11A, the 90° direction fiber sheets 11B, and the 45° direction fiber sheets 11C, the −45° direction fiber sheets 11D may be provided.

Also, it is possible to also change a ratio of the 0° direction fiber sheets 11A, the 90° direction fiber sheets 11B, the 45° direction fiber sheets 11C, and the −45° direction fiber sheets 11D as appropriate.

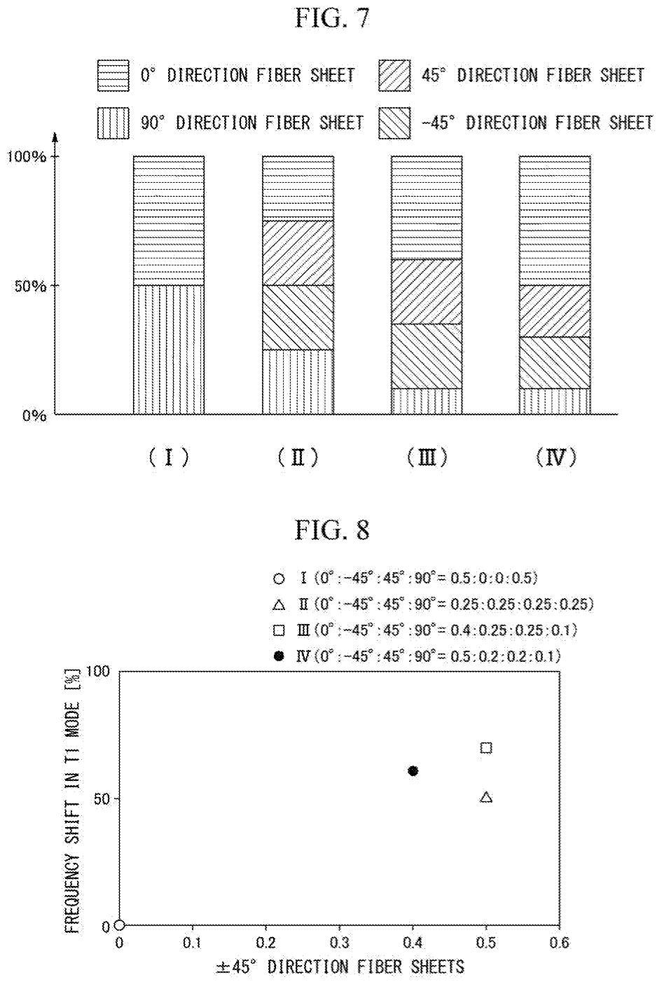

Here, a change in natural blade frequency of the fiber laminate 9 by changing the ratio of the fiber sheets 11 will be described using four types of fiber laminates 9. FIG. 7 is a graph for explaining the ratio of the fiber sheets 11 constituting the four types of fiber laminates 9.

As illustrated in FIG. 7, a first fiber laminate 9 (I) among the four types of fiber laminates 9 is a fiber laminate 9 constituted of a 0° direction fiber sheet 11A and a 90° direction fiber sheet 11B. The ratio of the 0° direction fiber sheets 11A and the 90° direction fiber sheets 11B is 50:50 in order of the 0° direction fiber sheets 11A and the 90° direction fiber sheets 11B. The first fiber laminate 9 does not have the 45° direction fiber sheets 11C and the −45° direction fiber sheets 11D (hereinafter referred to as “±45° direction fiber sheets”).

A second fiber laminate 9 (II) is a fiber laminate 9 constituted of a 0° direction fiber sheet 11A, a 45° direction fiber sheet 11C, a −45° direction fiber sheet 11D, and a 90° direction fiber sheet 11B and a ratio of the 0° direction fiber sheet 11A, the 45° direction fiber sheet 11C, the −45° direction fiber sheet 11D, and the 90° direction fiber sheet 11B is 25:25:25:25 in order of the 0° direction fiber sheet 11A, the 45° direction fiber sheet 11C, the −45° direction fiber sheet 11D, and the 90° direction fiber sheet 11B. That is to say, the second fiber laminate 9 (II) has the 0° direction fiber sheet 11A, the 45° direction fiber sheet 11C, the −45° direction fiber sheet 11D, and the 90° direction fiber sheet 11B at the same proportion and a percentage of ±45° fiber sheets is 50%.

A third fiber laminate 9 (III) is a fiber laminate 9 constituted of a 0° direction fiber sheet 11A, a 45° direction fiber sheet 11C, a −45° direction fiber sheet 11D, and a 90° direction fiber sheet 11B as in the second fiber laminate 9 (II) and a ratio of the 0° direction fiber sheet 11A, the 45° direction fiber sheet 11C, the −45° direction fiber sheet 11D, and the 90° direction fiber sheet 11B is 40:25:25:10 in order of the 0° direction fiber sheet 11A, the 45° direction fiber sheet 11C, the −45° direction fiber sheet 11D, and the 90° direction fiber sheet 11B.

That is to say, in the third fiber laminate 9 (III), a percentage of ±45° direction fiber sheets is 50%.

A fourth fiber laminate 9 (IV) is a fiber laminate 9 constituted of a 0° direction fiber sheet 11A, a 45° direction fiber sheet 11C, a −45° direction fiber sheet 11D, and a 90° direction fiber sheet 11B as in the second fiber laminate 9 (II) and a ratio of the 0° direction fiber sheet 11A, the 45° direction fiber sheet 11C, the −45° direction fiber sheet 11D, and the 90° direction fiber sheet 11B is 70:10:10:10 in order of the 0° direction fiber sheet 11A, the 45° direction fiber sheet 11C, the −45° direction fiber sheet 11D, and the 90° direction fiber sheet 11B.

That is to say, in the fourth fiber laminate 9 (IV), a percentage of ±45° direction fiber sheets is 20%.

FIG. 8 is a graph for describing a frequency shift in a T1 mode (a twist mode) of four types of fiber laminates 9. A horizontal axis in FIG. 8 represents a percentage of the ±45° direction fiber sheets in the fiber laminate 9 and a vertical axis represents a frequency shift in the T1 mode based on the first fiber laminate 9 (I) in which the percentage of the ±45° direction fiber sheets is 0%.

As illustrated in FIG. 8, it is possible to change a frequency in the T1 mode by changing the ratio of the fiber sheets 11.

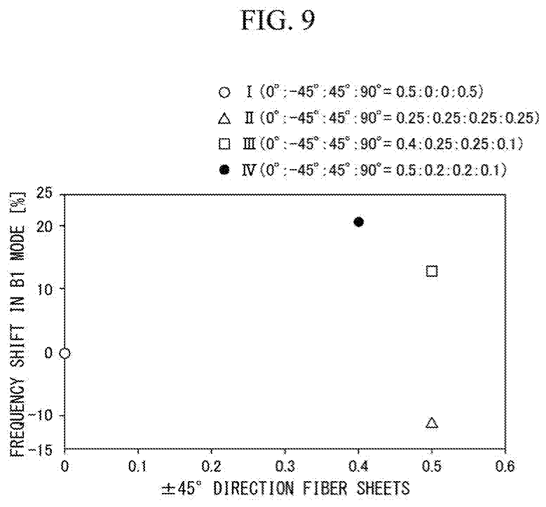

FIG. 9 is a graph for describing a frequency shift in a B1 mode (a bending mode in a blade height direction) of four types of fiber laminates 9. A horizontal axis in FIG. 9 represents a percentage of the ±45° direction fiber sheets in the fiber laminate 9 and a vertical axis represents a frequency shift in the B1 mode based on the first fiber laminate 9 (I) in which the percentage of the ±45° direction fiber sheets is 0%.

As illustrated in FIG. 9, it is possible to change a frequency in the B1 mode by changing the ratio of the fiber sheets 11.

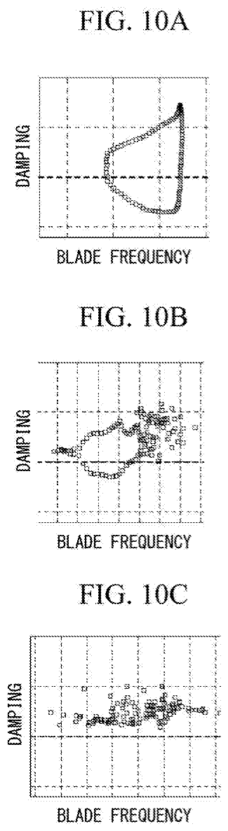

Also, when one or more rotor blades 6 having different fiber directions are provided into the rotor blade row 5, it is possible to average aerodynamic damping for each node diameter without affecting aerodynamic performance. That is to say, it is possible to provide a variation to the natural frequency by changing the fiber direction. FIGS. 10A, 10B, and 10C are graphs having a horizontal axis representing a blade frequency, having a vertical axis representing damping (aerodynamic damping), and obtained by plotting diameter modes (progressive waves and regressive waves) of nodes of the blade corresponding to the number of blades of the blade. FIG. 10A is a graph of a tune system in which there is no variation in a blade frequency. FIG. 10B is a graph of a mistune system in which a variation of a blade frequency is middle (a standard deviation of the natural blade frequency of a single blade is 1%). FIG. 10C is a graph of a random mistune system in which a variation of a blade frequency is large (a standard deviation of the natural blade frequency of a single blade is 3%).

With regard to the tune system as illustrated in FIG. 10A, when a variation is provided to the blade frequency as a mistune system as illustrated in FIGS. 10B and 10C, it is possible to average aerodynamic damping. That is to say, in the case of the mistune system as illustrated in FIGS. 10B and 10C, (1) a distribution of the frequency is distorted, a variation is generated in a distribution in the graph in a horizontal axis direction, and as a result, (2) the mistune system whose damping is unstable (damping of 0 or less) is changed to the mistune system whose damping is 0 or more and thus the mistune system is stable.

That is to say, when the mistune system is provided, it is possible to average aerodynamic damping and to increase aerodynamic damping. Thus, it is possible to reduce a vibration having small aerodynamic damping and a large forced vibration response.

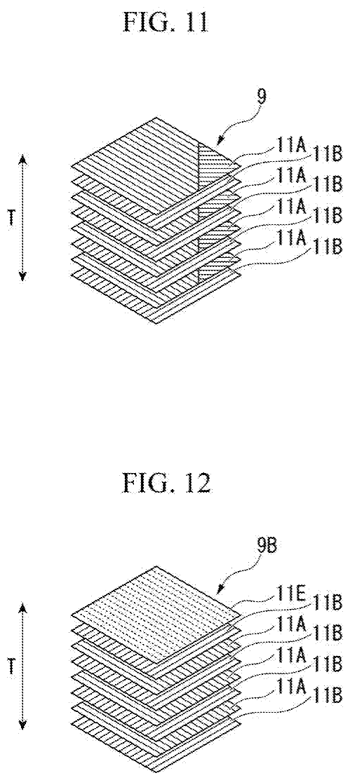

Although the fiber sheet 11 of any of the 0° direction fiber sheet 11A and the 90° direction fiber sheet 11B which are alternately laminated is changed to the 45° direction fiber sheet 11C in the second rotor blade 6B in the above embodiment, the present invention is not limited thereto. For example, as in a modified example illustrated in FIG. 11, a fiber angle of a part of at least one fiber sheet 11 of the 0° direction fiber sheet 11A and the 90° direction fiber sheet 11B which are alternately laminated may be changed.

Also, although a constitution in which the 0° direction fiber sheet 11A and the 90° direction fiber sheet 11B are alternately laminated and the fiber sheet 11 of any of the 0° direction fiber sheet 11A and the 90° direction fiber sheet 11B is changed to the 45° direction fiber sheet 11C is provided in the above embodiment, the number of fiber sheets 11 changed to the 45° direction fiber sheet 11C is not limited to one and may be one or more.

Furthermore, although the first rotor blade 6A and the second rotor blade 6B are arranged differently from each other in the circumferential direction in the above embodiment, the present invention is not limited thereto. In addition, when the rotor 3 is viewed from the axial direction, for example, the first rotor blade 6A may be arranged in one region and the second rotor blade 6B may be arranged in the opposite region.

Furthermore, although the fiber constituting the fiber sheets 11 is a carbon fiber in the above embodiment, the present invention is not limited thereto. Examples of the fiber constituting the fiber sheets 11 include glass fibers, aramid fibers, ceramic fibers, and alumina fibers.

### Second Embodiment

A rotor blade row in a second embodiment of the present invention will be described in detail below with reference to the drawings. In this embodiment, differences between the above-described first embodiment and the second embodiment will be mainly described and a description of constituent elements that are the same as those of the above-described first embodiment will be omitted.

In the second rotor blade 6B in this embodiment, the fiber sheet 11 of any of the 0° direction fiber sheets 11A and the 90° direction fiber sheets 11B which are alternately laminated is changed to a fiber sheet 11 having a different fiber type.

FIG. 12 is a schematic diagram for explaining the fiber direction of the fiber sheet 11 constituting a fiber laminate 9B of the second rotor blade 6B (refer to FIG. 2) among the plurality of rotor blades constituting the rotor blade row. The fiber laminate 9B in this embodiment includes a plurality of 0° direction fiber sheets 11A, a plurality of 90° direction fiber sheets 11B, and 0° direction fiber sheets 11E of a different fiber type.

For example, the 0° direction fiber sheets 11A and the 90° direction fiber sheets 11B can be formed of a polyacrylonitrile (PAN)-based carbon fiber and the 0° direction fiber sheets 11E of a different fiber type can be formed of a pitch-based carbon fiber.

According to the above embodiment, it is possible to differentiate the structures of the first rotor blade 6A and the second rotor blade 6B without changing the fiber direction.

Although the fiber sheet 11 of any of the 0° direction fiber sheet 11A and the 90° direction fiber sheet 11B which are alternately laminated is changed to the 0° direction fiber sheet 11E of a different fiber type in the second rotor blade 6B in the above embodiment, the present invention is not limited thereto. For example, a fiber type of part of the fiber sheet 11 of at least one of the 0° direction fiber sheet 11A and the 90° direction fiber sheet 11B which are alternately laminated may be changed.

### Third Embodiment

A rotor blade row in a third embodiment of the present invention will be described in detail below with reference to the drawings. In this embodiment, differences between the above-described second embodiment and the third embodiment will be mainly described and a description of constituent elements that are the same as those of the above-described second embodiment will be omitted.

In a second rotor blade 6B in this embodiment, a fiber sheet 11 of any of a 0° direction fiber sheet 11A and a 90° direction fiber sheet 11B which are alternately laminated is changed to a fiber sheet having a different fiber diameter.

A fiber laminate 9 includes a plurality of 0° direction fiber sheets 11A, a plurality of 90° direction fiber sheets 11B, and 0° direction fiber sheets having a different fiber diameter.

For example, a fiber diameter of a carbon fiber of the 0° direction fiber sheets 11A and the 90° direction fiber sheets 11B is 5 μm and a fiber diameter of a carbon fiber of the 0° direction fiber sheets having a different fiber diameter is 10 μm.

According to the above embodiment, it is possible to differentiate a structure of a first rotor blade 6A and a second rotor blade 6B without changing a fiber direction as in the rotor blade row 5B in the second embodiment.

Although a fiber sheet 11 of any of the 0° direction fiber sheet 11A and the 90° direction fiber sheet 11B which are alternately laminated is changed to a fiber sheet having a different fiber diameter in the second rotor blades 6B in the above embodiment, the present invention is not limited thereto. For example, a fiber diameter of part of at least one fiber sheet 11 of the 0° direction fiber sheet 11A and the 90° direction fiber sheet 11B which are alternately laminated may be changed.

### Fourth Embodiment

A rotor blade row in a fourth embodiment of the present invention will be described in detail below with reference to the drawings. In this embodiment, differences between the above-described first embodiment and the fourth embodiment will be mainly described and a description of constituent elements that are the same as those of the above-described first embodiment will be omitted.

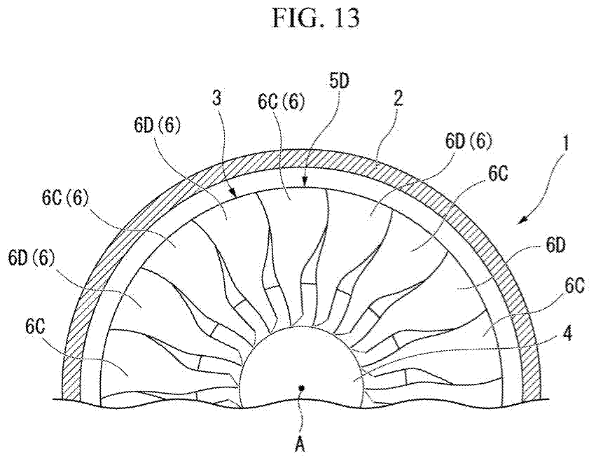

FIG. 13 is a front view of a compressor 1 having a rotor blade row 5D in this embodiment. The rotor blade row 5D in this embodiment has a structure in which carbon fibers are easily detached from only a specific rotor blade 6. In order to make the structure in which the carbon fibers are easily detached, in a second rotor blade 6D of the rotor blade row 5 in this embodiment, the direction of the stress generation caused by the flutter mode is the same as the fiber direction of the carbon fibers. Thus, when vibrations exceeding an assumed extent occur, the second rotor blade 6D has the structure in which the carbon fibers are easily detached. Even when vibrations exceeding an assumed extent occur, a first rotor blade 6C has a normal constitution in which a frequency does not change.

According to the above embodiment, when a rotor blade 6 vibrates to exceed an assumed extent, a frequency greatly changes by making a structure in which carbon fibers are easily detached from only a second rotor blade 6D which is the specific rotor blade 6.

Thus, a degree of mistuning increases and a large flutter occurs on some of rotor blades 6. If a large flutter occurs in some of the rotor blades 6, carbon fibers are detached, but this detachment can be easily detected. Thus, a defect can be found at an early stage. Therefore, it is possible to prevent fatal damage, for example, a situation in which blades fly from their roots and collide with rear-stage blades to damage many blades and a casing in advance.

While the embodiments of the present invention have been described in detail above with reference to the drawings, the specific constitution is not limited to the embodiments and includes a design change or the like without departing from the gist of the present invention.

Although the structure of the fiber laminate 9 is different from that of the rotor blade 6 in the rotor blade row 5 in the above embodiment, the present invention is not limited thereto. In addition, the structure of the fiber laminate 9 may be different from that of the stator blade in the stator blade row.

Also, a fiber direction of one fiber sheet 11 among the plurality of fiber sheets 11 of the fiber laminate 9 constituting the second rotor blade 6B may be differentiated and a fiber type of the other fiber sheet 11 may be differentiated.

### INDUSTRIAL APPLICABILITY

According to an aspect of the present invention, it is possible to reduce vibration stress of a blade row.

### REFERENCE SIGNS LIST

1 Compressor
2 Casing
3 Rotor
4 Rotary shaft
5 Rotor blade row
6 Rotor blade
6A First rotor blade
6B Second rotor blade
8 Core member
9 Fiber laminate
10 Resin
11 Fiber sheet
11A 0° direction fiber sheet
11B 90° direction fiber sheet
11C 45° direction fiber sheet
11D −45° direction fiber sheet
13 Intake duct
15 Compressor stator blade row
16 Compressor stator blade
20 Combustion chamber
30 Turbine
31 Turbine rotor
32 Turbine casing
91 Gas turbine rotor
92 Gas turbine casing
100 Jet engine
T Blade thickness direction

1. A rotary machine, comprising:
a rotary shaft configured to rotate around an axis; and
a blade row including a plurality of blades at intervals in a circumferential direction of the axis,
wherein each of the blades includes:
a fiber laminate obtained by laminating a plurality of fiber sheets; and
a resin used for forming an outer shape of the blade by impregnating the fiber laminate, and
at least two of the blades in the blade row have fiber laminates having different structures.

2. The rotary machine according to claim 1, wherein the plurality of blades have the same outer shape.

3. The rotary machine according to claim 1, wherein, in the fiber laminates having structures different from each other, fiber directions of some of fiber sheets of one layer or more among the plurality of fiber sheets are different.

4. The rotary machine according to claim 1, wherein, in the fiber laminates having structures different from each other, fiber types of some of fiber sheets of one layer or more among the plurality of fiber sheets are different.

5. The rotary machine according to claim 1, wherein, in the fiber laminates having structures different from each other, fiber diameters of some of fiber sheets of one layer or more among the plurality of fiber sheets are different.
